(19) United States
(12) Patent Application Publication
(10) Pub. No.: US 2006/0015663 A1
(43) Pub. Date: Jan. 19, 2006

(54) Wireless communications device for expanding storage capacity of portable electronic equipment

(75) Inventors: Timothy Alan Dietz, Austin, TX (US); Walid M. Kobrosly, Round Rock, TX (US); Nadeem Malik, Austin, TX (US)

Correspondence Address: JANIS E. CLEMENTS, 3112 LOMITA DRIVE, AUSTIN, TX, 78738, US

(73) Assignee: International Business Machines Corporation, Armonk, NY (US)

(21) Appl. No.: 10/891,769

(22) Filed: Jul. 15, 2004

(51) Int. Cl. G06F 13/12

(52) U.S. Cl. 710/62

(57) ABSTRACT

A system, method, and related computer program for expanding storage capacity of portable electronic equipment via wireless communications device. The portable electronic equipment can be a such equipment as a digital camera, MP3 player, personal computer, as well as a digital wallet. The present invention provides a wireless communications device for expanding the storage capacity of portable electronic equipment having limited storage capacity via the receiving means in the device, and means in the equipment for transferring stored data to the device. The device is then able to convert the data into a form suitable for wireless transmission to a receiving storage facility. The storage facility is able to wirelessly return data in said form back to the device, and the device is able to reconvert the returned data into the original form of the data. There is also a caching file system for retaining shadowed memory data in the wireless communications device to lessen delays in wireless communication.

### TECHNICAL FIELD

The present invention relates to computer controlled consumer electronics devices or instruments, such as digital cameras, personal computers, MP3 players, and digital wallets, and specifically to the expansion of storage capacity of these devices by use of a wireless communications device.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controlled instrumentation. The Universal Serial Bus (USB) was originally developed in 1995 by Intel, Compaq, DEC, IBM, Microsoft, NEC, and Northern Telecom, to define an external expansion bus that simplified adding peripherals to a PC with low cost to the user. The USB has a data transfer rate of 12 megabits per second (Mbps) for connecting peripherals to a microcomputer. USB can connect up to 127 peripherals, such as external CD-ROM drives, printers, modems, mice, and keyboards to the system through a single, general purpose port, which is accomplished by daisy chaining peripherals together. USB is designed to add such devices without having to shut down and restart the system. Currently, USB enjoys tremendous success in the marketplace, and most peripheral vendors are developing products to this specification. Virtually all new PCs have one or more USB ports included thereon.

To better understand USB, an understanding of the roles of each of its major elements is necessary, which is described in greater detail in the article “Understanding Universal Serial Bus Part 1: USB Basics”, Embedded Systems Programming, John Canosa, Miller Freeman, San Francisco, Calif., USA, June 1997. These major elements are the host PC hardware and software, the hub, and the peripheral. The role of the system software is to provide a uniform view of I/O systems for all applications software. The system software hides hardware implementation details causing the application software to be more portable. For the USB I/O subsystem, the system software manages the dynamic attach and detach of peripherals. This phase is called enumeration, and involves communicating with the peripheral to discover the identity of a device driver that should be loaded if it has not been loaded yet. A unique address is assigned to each peripheral during enumeration to be used for run-time data transfers. During run-time, the host PC initiates transactions to specific peripherals, and each peripheral accepts its transactions and responds accordingly. The host PC software incorporates the peripheral into the system power management scheme and can manage overall system power without user interaction.

The role of the hub is to provide managed power to attached peripherals, in addition to its obvious role of providing additional connectivity for USB peripherals. The hub recognizes dynamic attachment of a peripheral and provides at least 0.5 W of power per peripheral during initialization. Under control of the host PC software, the hub may provide more device power, up to a maximum of 2.5 W, for peripheral operation. A newly attached hub will be assigned its unique address, and hubs may be cascaded up to five levels deep. During run-time, a hub operates as a bi-directional repeater and will repeat USB signals as required on upstream (towards the host) and downstream (towards the device) cables. The hub also monitors these signals and handles transactions addressed to itself. All other transactions are repeated to attached devices. A hub supports both 12 Mbps (full-speed) and 1.5 Mbps (low-speed) peripherals. USB, version 2.0, offers its users an additional range of higher performance peripherals, such as video-conferencing cameras, and increases data throughput by a factor of 40, since it has a higher bandwidth. USB 2.0 has 480 Mbps bandwidth.

All USB peripherals must react to request transactions sent from the host PC. The peripheral responds to control request transactions sent from the host PC. The peripheral responds to control transactions that, for example, request detailed information about the device and its configuration. The peripheral sends and receives data to/from the host using a standard USB data format. This standardized data movement to/from the PC host and interpretation by the peripheral gives USB its enormous flexibility with little PC host software changes. USB peripherals can operate at 12 Mbps or 1.5 Mbps.

Also included in the present invention is a caching file system for retaining shadowed memory data, which has been contemplated previously. However, in the present invention, the caching file system retains the shadowed memory data in the wireless communications device, which lessens delays in wireless communication.

### SUMMARY OF THE PRESENT INVENTION

The present invention provides a solution to the problems related to limited storage capacity of portable electronic equipment. Accordingly, the present invention provides a wireless communications device for expanding the storage capacity of portable electronic equipment having limited storage capacity via the receiving means in the device, and means in the equipment for transferring stored data to the device. The device is then able to convert the data into a form suitable for wireless transmission to a receiving storage facility. The storage facility is able to wirelessly return data in said form back to the device, and the device is able to reconvert the returned data into the original form of the data. The portable electronic equipment can be a digital camera, MP3 player, personal computer, as well as a digital wallet.

There is also a caching file system for retaining shadowed memory data in the wireless communications device to lessen delays in wireless communication.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a wireless communications device in accordance with the present invention being inserted into a computer controlled portable electronic instrument, i.e. a digital camera, and wirelessly transmitting data to a receiving storage facility, i.e. a laptop computer's storage area;

FIG. 2 is a block diagram of a simplified control circuitry on controller integrated circuitry on an IC chip on a wireless communications device in accordance with this invention;

FIG. 3 is an illustrative flowchart in accordance with this invention showing how the storage capacity of portable electronic equipment is expanded by a wireless communications device; and

FIG. 4 is a flowchart of an illustrative run of the process set up in FIG. 3.

### DETAILED DESCRIPTION OF THE PREFERRED EMBODIMENT

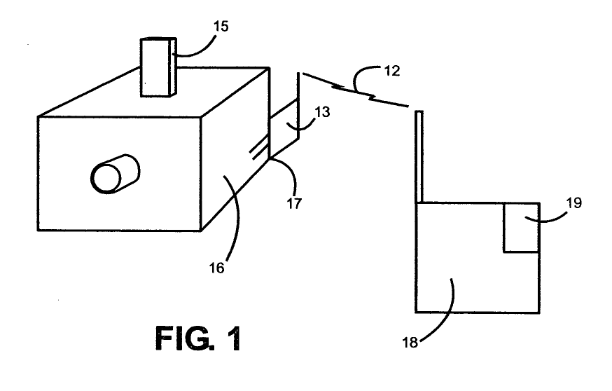

Referring to FIG. 1, a typical use of the wireless communications device of the present invention in connection with a computer controlled instrument or portable electronic equipment, e.g. a digital camera, is shown. The camera 16 has a USB port 17 into which the wireless communications device 13 may be removably inserted to operatively engage the computer system in the camera to function as an expansion of the equipment's storage capacity when data is wirelessly transferred 12 to the storage facility 19 of a second computer controlled instrument 18, such as a PC or laptop computer, as will be hereinafter described in greater detail. The digital camera 16 has its own limited storage capacity via a memory stick 15 or some other memory device. This limited storage is expanded by use of the present invention. Of course, the operations to be described will be applicable to a wireless communications device and computer controlled instrument co-action.

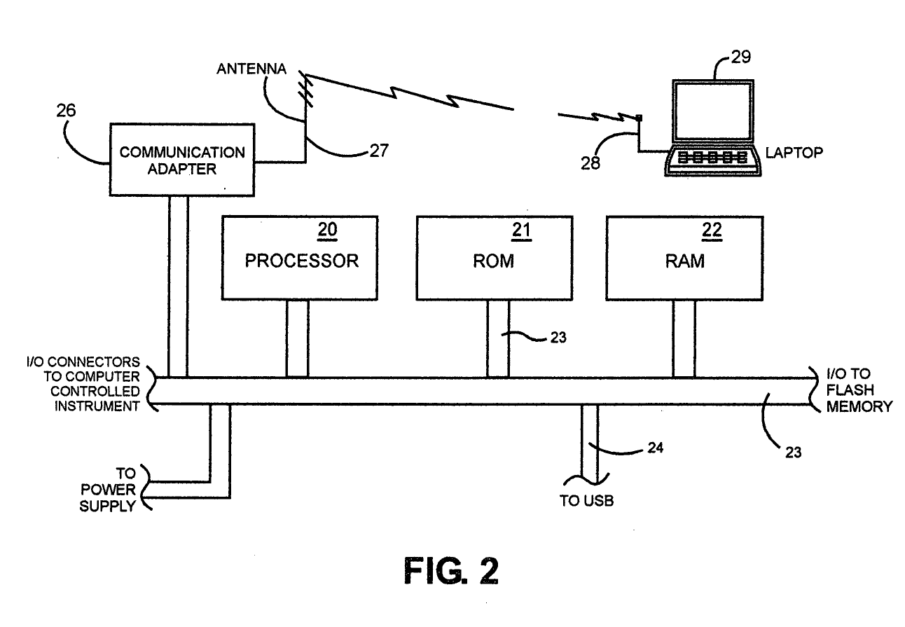

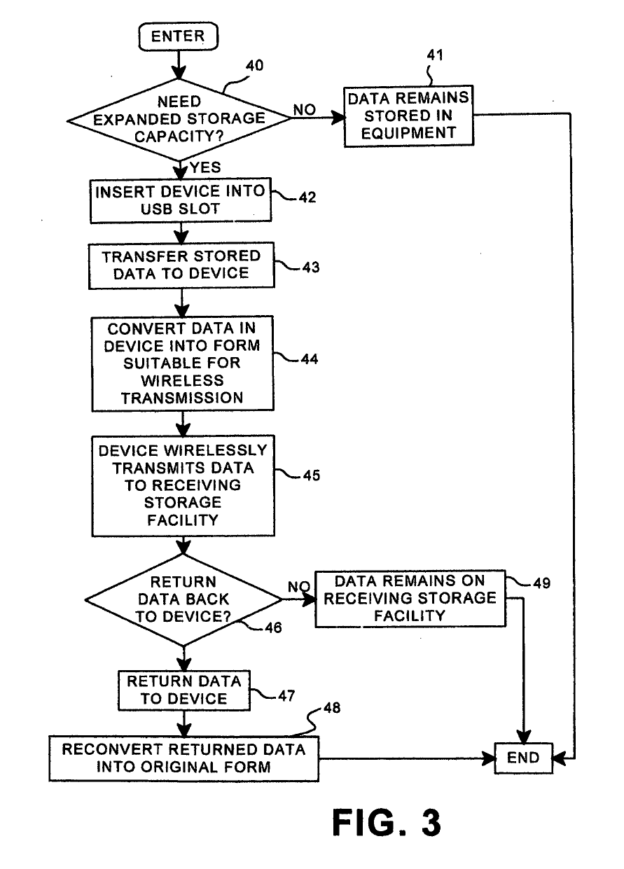

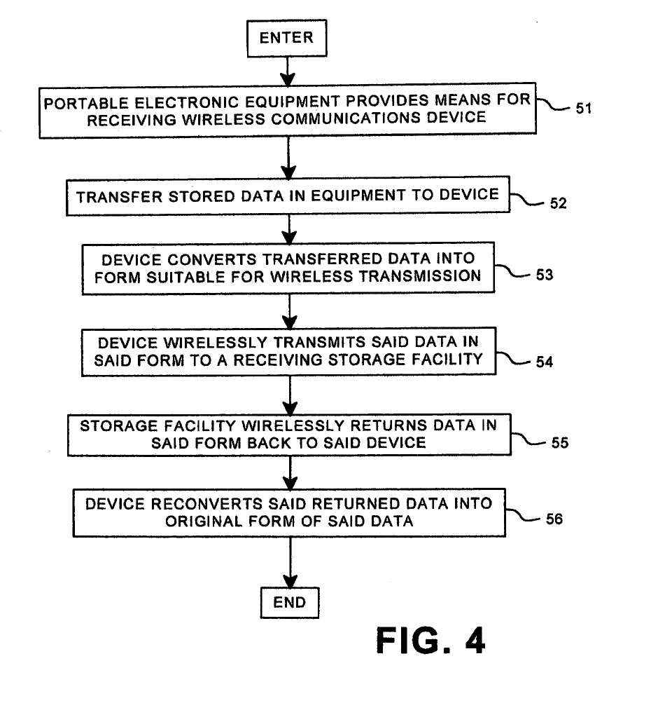

FIG. 2 is a block diagram of simplified control circuitry on a wireless communications device 13 in accordance with this invention. The wireless communications device 13 contains data processors 20, operating systems stored in RAM 22 and a permanent programmable memory, and a programmable ROM 21. The wireless communications device 13 contains a system bus 23 connected via I/O output at one end to the conventional connectors of the wireless communications device 13 to the computer controlled instrument. A communications adapter 26 allows wireless transmissions via an antenna 27 to a wireless communications device, such as a laptop computer 29, received by that device's receiving means 28. In accordance with the present invention, this relatively standard structure is modified to have an appropriate connection via bus 24 to the USB port, in accordance with the routines illustrated in FIG. 3 and FIG. 4, to be subsequently described.

There is also shown a bus branch to a power supply. Where the wireless communications device is functioning already operatively inserted into the computer controlled instrument, the power supply of the instrument itself may be used for this function. By use of the present invention, the user is able to wirelessly transmit stored data from portable electronic equipment, e.g. a digital camera, to a storage facility in another computer controlled instrument, e.g. a laptop computer.

The running of the process set up in FIG. 2 will now be described with respect to the flowchart of FIG. 3. The flowchart represents some steps in a routine that will illustrate the operation of the invention. The user of portable electronic equipment determines whether expanded storage capacity is needed in said equipment, step 40. If No, the data remains stored in the portable electronic equipment unless otherwise retrieved or transferred in some other manner, step 41. If Yes, the user inserts the wireless communications device into said equipment via a USB slot, step 42. Stored data from said equipment is transferred to the wireless communications device, step 43. The transferred data is converted in said device into a form suitable for wireless transmission, step 44. The device wirelessly transmits said data in said form to a receiving storage facility, step 45. A determination is made as to whether the data is returned back to said device, step 46. If Yes, the storage facility wirelessly returns data in said form back to said device, step 47. The device reconverts said returned data into the original form of said data, step 48. If No, the data remains stored in the storage facility, step 49.

Referring now to FIG. 4, an illustrative flowchart in accordance with this invention showing how the storage capacity of portable electronic equipment is expanded via a wireless communications device, the portable electronic equipment provides means for receiving the wireless communications device, step 51. The stored data in said equipment is then transferred to said device, step 52. The device then converts the transferred data into a form suitable for wireless transmission, step 53. Wireless data transmission mechanisms or protocols can include infrared, Bluetooth, 802.11a/b/g, or unlicensed 2.4 and 5 Ghz bands, such as wireless home telephones. The device wirelessly transmits said data in said form to a receiving storage facility, step 54. The storage facility can then wirelessly return data in said form back to said device, step 55. The device reconverts said returned data into the original form of said data, step 56. A caching file system is present for retaining shadowed memory data in the device to lessen delays in wireless communication.

Although certain preferred embodiments have been shown and described, it will be understood that many changes and modifications may be made therein without departing from the scope and intent of the appended claims.

What is claimed is:

1. A wireless communications device for expanding storage capacity of portable electronic equipment having limited storage capacity, comprising:
means in said equipment for receiving said device;
means in said equipment for transferring stored data to said device;
means in said device for converting said transferred data into a form suitable for wireless transmission; and
means in said device for wirelessly transmitting said data in said form to a receiving storage facility.

2. The wireless communications device of claim 1 further including:
means associated with storage facility for wirelessly returning data in said form back to said device; and
means in said device for reconverting said returned data into the original form of said data.

3. The wireless communications device of claim 2 wherein the portable electronic equipment is a digital camera.

4. The wireless communications device of claim 2 wherein the portable electronic equipment is an MP3 player.

5. The wireless communications device of claim 2 wherein the portable electronic equipment is a personal computer.

6. The wireless communications device of claim 2 wherein the portable electronic equipment is a wireless communications enabled digital wallet.

7. The wireless communications device of claim 2 further comprising a caching file system for retaining shadowed memory data in the wireless communications device to lessen delays in wireless communication.

8. A method for expanding storage capacity of portable electronic equipment having limited storage capacity via a wireless communications device, including the steps of:
receiving said device in said equipment;
transferring stored data from said equipment to said device;
converting said transferred data into a form suitable for wireless transmission in said device; and
wirelessly transmitting said data in said form to a receiving storage facility in said device.

9. The method of claim 8 further including the steps of:
wirelessly returning data in said form from said storage facility back to said device; and
reconverting said returned data into the original form of said data in said device.

10. The method of claim 9 wherein the portable electronic equipment is a digital camera.

11. The method of claim 9 wherein the portable electronic equipment is an MP3 player.

12. The method of claim 9 wherein the portable electronic equipment is a personal computer.

13. The method of claim 9 wherein the portable electronic equipment is a wireless communications enabled digital wallet.

14. The method of claim 9 further including means for a caching file system for retaining shadowed memory data in the wireless communications device to lessen delays in wireless communication.

15. A computer program having code recorded on a computer readable medium for expanding storage capacity of portable electronic equipment having limited storage capacity via a wireless communications device, comprising:
means in said equipment for receiving said device;
means in said equipment for transferring stored data to said device;
means in said device for converting said transferred data into a form suitable for wireless transmission; and
means in said device for wirelessly transmitting said data in said form to a receiving storage facility.

16. The computer program of claim 15 further including:
means associated with storage facility for wirelessly returning data in said form back to said device; and
means in said device for reconverting said returned data into the original form of said data.

17. The computer program of claim 16 wherein the portable electronic equipment is a digital camera.

18. The computer program of claim 16 wherein the portable electronic equipment is an MP3 player.

19. The computer program of claim 16 wherein the portable electronic equipment is a wireless communications enabled digital wallet.

20. The computer program of claim 16 further comprising a caching file system for retaining shadowed memory data in the wireless communications device to lessen delays in wireless communication.
